(19) United States
(12) Patent Application Publication
(10) Pub. No.: US 2026/0152344 A1
(43) Pub. Date: Jun. 4, 2026

(54) MULTI-STREAM TRASH RECEPTACLE WITH CONFIGURABLE DOLLY PLATFORM

(71) Applicant: SUNCAST TECHNOLOGIES, LLC, Palm Beach Gardens, FL (US)

(72) Inventors: Stephen Whitehead, Elgin, IL (US); Robert Kopp, Elburn, IL (US); Torrence Anderson, Overland Park, KS (US)

(21) Appl. No.: 18/964,473

(22) Filed: Dec. 1, 2024

(51) Int. Cl. B65F 3/00; B65F 1/00; B65F 1/14; B65F 1/16

(52) U.S. Cl. CPC B65F 3/001; B65F 1/0053; B65F 1/1468; B65F 1/1607; B65F 3/005; B65F 2001/0086; B65F 2210/138; B65F 2210/176; B65F 2220/108; B65F 2250/114

(57) ABSTRACT

Briefly, the invention involves a multi-stream trash receptacle having a carrier configured for attachment to any number of like constructed carriers. The trash receptacle and the carrier may be used as a single trash can, with or without wheels, or the trash can and carrier may be connected to other carriers and trash cans to construct a multi-stream trash can suitable for uses such as recycling. In this manner, the trash cans may be secured in a side by side relationship with specialized lids relating to the type of refuse they are intended to receive. The dollies can be utilized without wheels or with them. The trash cans are removable from the carriers for dumping or cleaning, and replaceable to the assembled structure.

### FIELD OF INVENTION

The present invention generally relates to trash receptacles and, more particularly, to a trash receptacle for separation of refuse from different waste streams. The trash receptacle is nestable for shipment and includes a dolly that is constructed for attaching together multiple receptacles with or without wheels.

### BACKGROUND INFORMATION

Wheeled trash receptacles are known in the art. They generally assist the user in moving a large and heavy amount of trash or refuse by functioning like a two wheeled cart when loaded with weight. This construction allows the user to tip the can toward the user to place the weight over the wheels. The loaded trash receptacle can then be moved to a desired location before being allowed to fall back onto the bottom surface of the trash can, which may lift the wheels away from the ground surface. Unfortunately, wheeled trash receptacles that include widely spaced wheels for stability are typically not nestable and thus shipment adds significant cost to the consumer product. Wheeled trash receptacles that are nestable typically require the wheels to be moved inward, making the trash receptacle unstable when the wheels are used.

Another drawback associated with wheeled trash receptacles is that refuse is not easily separated for recycling since the wheeled trash receptacles only have one bin for placing the refuse. Recycling containers are also known. These containers typically include multiple trash cans that are permanently secured together with straps and fasteners or include complex systems for connecting the cans together. For example, U.S. Pat. No. 5,704,625, assigned to Rubbermaid, entitled “Trash Container Carrier”, discloses a carrier including a platform body for supporting a refuse container having a base, first and second side walls and a generally tapered front wall. Interlocking members assist in securing the carrier together with a like constructed carrier. For interlocking, the carrier is built to include outriggers which extend into openings on the second carrier. When the carrier is inverted, a locking mechanism can be extended to catch the outriggers. The carrier can then be up-righted for placing the can on the interlocked carriers. The interlocking members may be separated in response to pressure on a foot pedal secured to the carrier which operates a linkage to the lock. In addition to the complex linkage required to operate the lock, this design requires that the dolly be inverted to interlock the carriers.

1Finally, there are ergonomic needs that a multi-stream refuse container must satisfy in order to achieve acceptance by the end user. The system must be easily and quickly assembled using minimal hardware and requiring a minimal number of tools. Further, the system should not require excessive strength to assemble or include heavy component parts. Moreover, the system must assemble together in such a way so as not to detract from the aesthetic appearance of the assembled multi-stream trash receptacle. Still yet, the wheel spacer should be easily disassembled to allow the user to reconfigure his trash receptacle as needed.

Thus, the present invention provides a trash receptacle that is nestable for shipment. The trash receptacle is constructed to interlock with a carrier that can be secured to other carriers for securing multiple trash receptacles together. The dollies may be used with or without wheels. This construction overcomes the complex systems of the prior art and provides significant advantage over large boxes or the like constructed to accept multiple trash cans. The carrier structure of the present invention not only provides for relative ease in the assembly, but it also permits disassembly and removal or addition of wheels on the multi-stream trash receptacle assembly as desired.

### SUMMARY OF THE INVENTION

Briefly, the invention involves a multi-stream trash receptacle having a carrier configured for attachment to any number of like constructed carriers. The trash receptacle and the carrier may be used as a single trash can with or without wheels, or the trash can and carrier may be connected to other carriers and trash cans to construct a multi-stream trash can suitable for uses such as recycling. In this manner, the trash cans may be secured in a side by side relationship with specialized lids relating to the type of refuse they are intended to receive. The dollies can be utilized without wheels or with them. The trash cans are removable from the carriers for dumping or cleaning and replaceable to the assembled structure.

Accordingly, it is an objective of the present invention to provide a wheeled and nestable trash receptacle.

It is a further objective of the present invention to provide a wheeled and nestable trash receptacle that includes wheels movable between a nestable and a non-nestable position.

It is yet a further objective of the present invention to provide a wheel spacer that can be removed and replaced to change the wheel position between the nestable and the non-nestable position.

1Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a top, front, left perspective view of one embodiment of a multi-stream trash can;

FIG. 2 is a top, rear, right perspective view of the multi-stream trash can;

FIG. 3 is a bottom, front, left view of the multi-stream trash can;

FIG. 4 is a bottom, rear, right perspective view of the multi-stream trash can;

FIG. 5 is a front view of the multi-stream trash can;

FIG. 6 is a rear view of the multi-stream trash can;

FIG. 7A is a left side view of one multi-stream trash can and carrier;

FIG. 7B is a right side view of one multi-stream trash can and carrier;

FIG. 8 is a front view of the multi-stream trash can, including the carrier and wheels;

FIG. 9 is top view of the multi-stream trash can, including the carrier and wheels;

FIG. 10 is a bottom view of the multi-stream trash can, including the carrier and wheels;

FIG. 11 is a top, front, left perspective view of the multi-stream trash can including the carrier and without the wheels;

FIG. 12 is a top, rear, left perspective view of the multi-stream trash can including the carrier and without the wheels;

FIG. 13 is a bottom, front, right perspective view of the multi-stream trash can, including the carrier and without the wheels, illustrating the attachment of the carriers;

FIG. 14 is a front view of the multi-stream trash can, including the carrier and without the wheels;

FIG. 15 is a rear view of the multi-stream trash can, including the carrier and without the wheels;

FIG. 16 is a right side view of the multi-stream trash can, including the carrier and without the wheels;

FIG. 17 is a bottom view illustrating the carriers assembled together without casters;

FIG. 18 is a top, front, right partially exploded perspective view of the multi-stream trash cans including the carriers and the casters;

FIG. 19 is a top, rear, right partially exploded perspective view of the multi-stream trash cans including the carriers and the casters;

FIG. 20 is a bottom, front, right partially exploded perspective view, illustrating the assembly of the casters and the carrier tie bars;

FIG. 21A is a bottom front perspective view of a caster mount for independent carriers;

FIG. 21B is a top front perspective view of a caster mount;

FIG. 21C is a front view of a caster mount;

FIG. 21D is a top view of a caster mount;

FIG. 21E is a bottom view of a caster mount;

FIG. 22A is a top, front, left perspective view of a carrier tie bar and caster mount;

FIG. 22B is a bottom, front, right perspective view of a carrier tie bar and caster mount;

FIG. 22C is a front view of a carrier tie bar and caster mount;

FIG. 22D is an end view of a carrier tie bar and caster mount;

FIG. 22E is a top view of a carrier tie bar and caster mount; and

FIG. 22F is a bottom view of a carrier tie bar and caster mount.

### 1DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

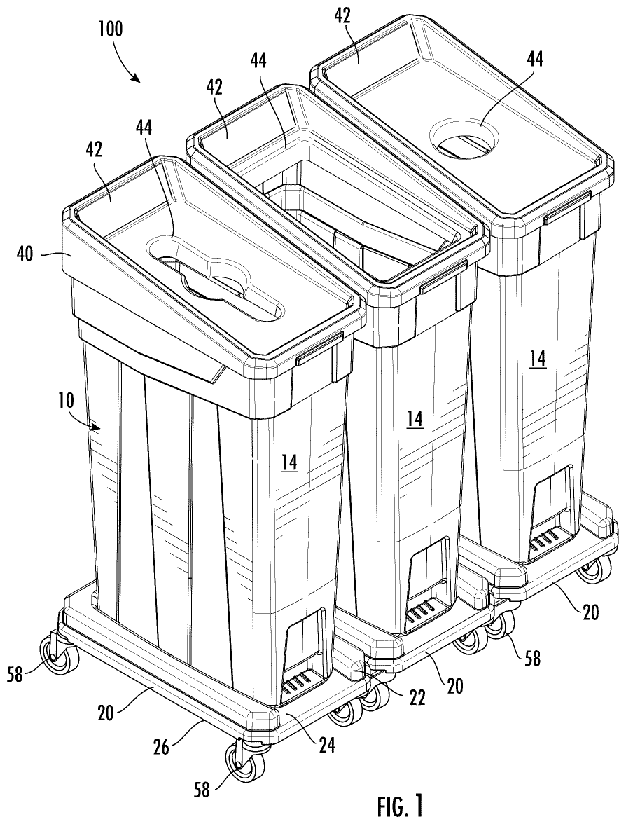

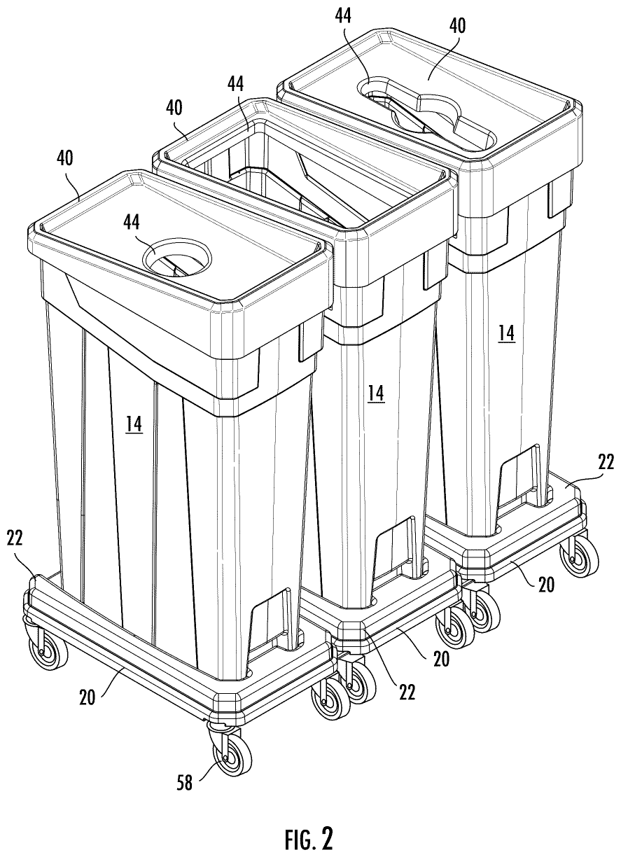

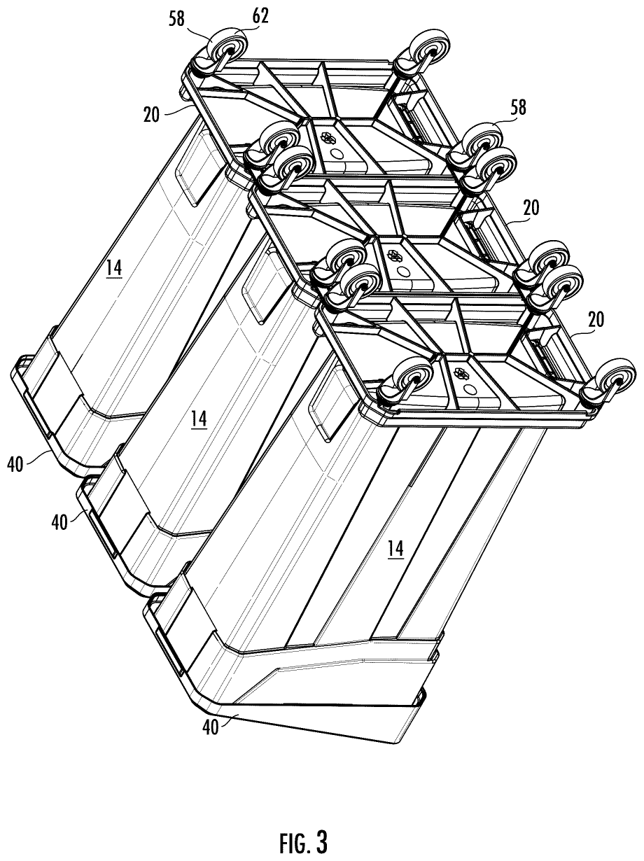

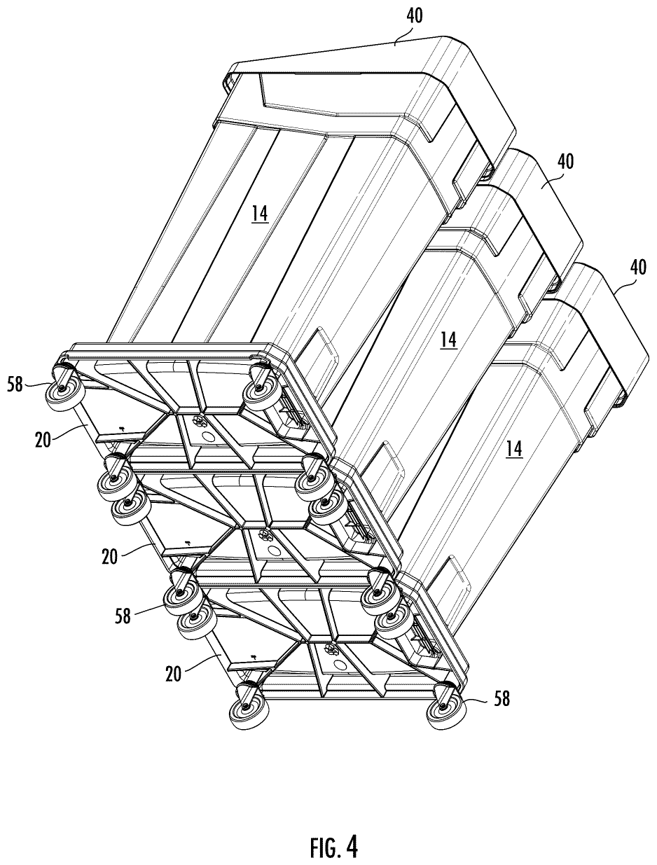

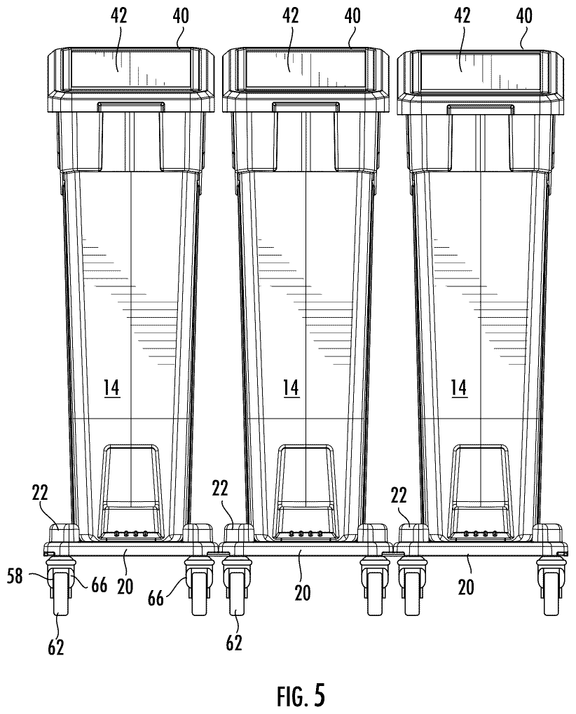

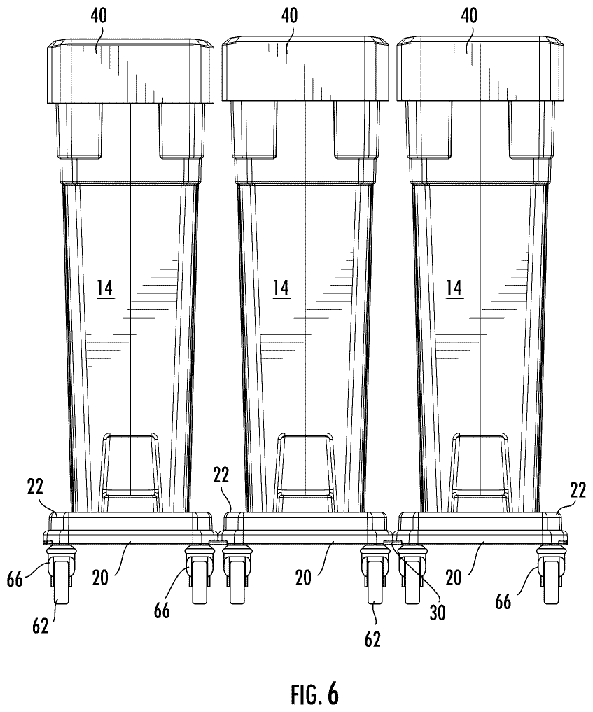

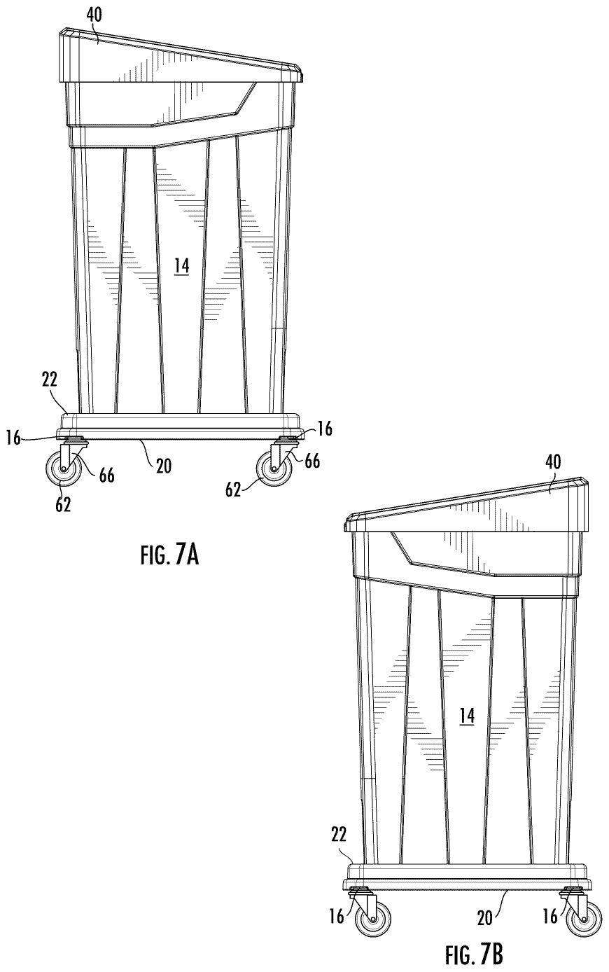

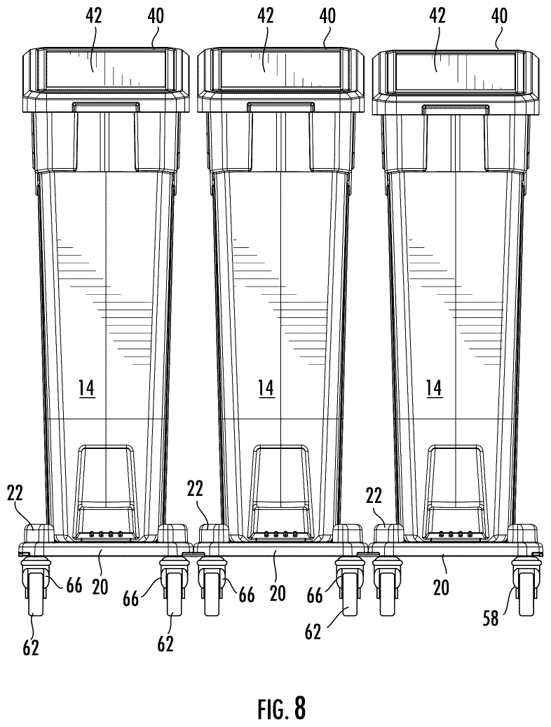

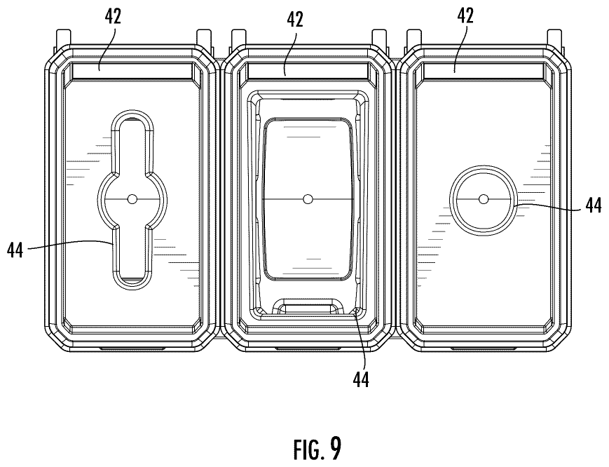

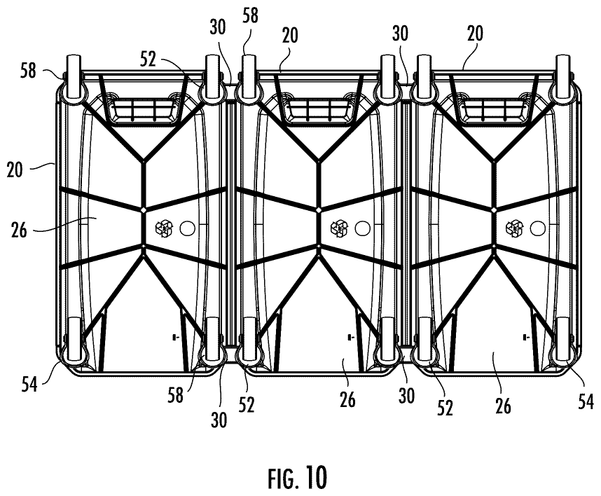

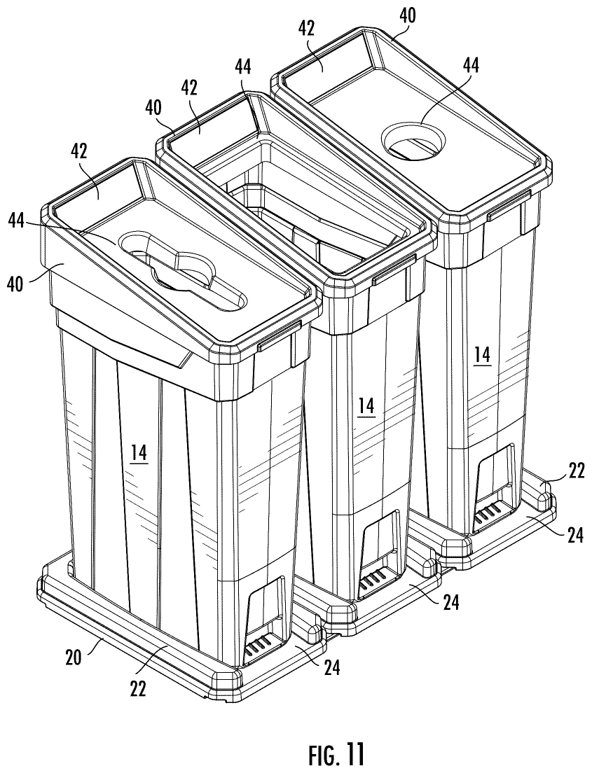

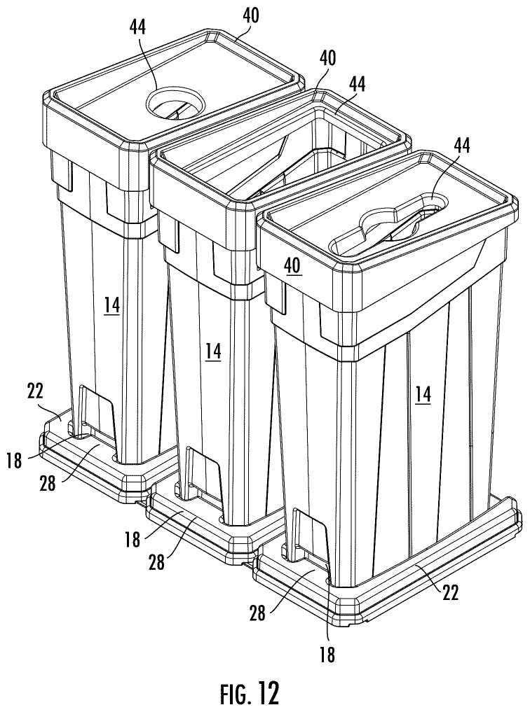

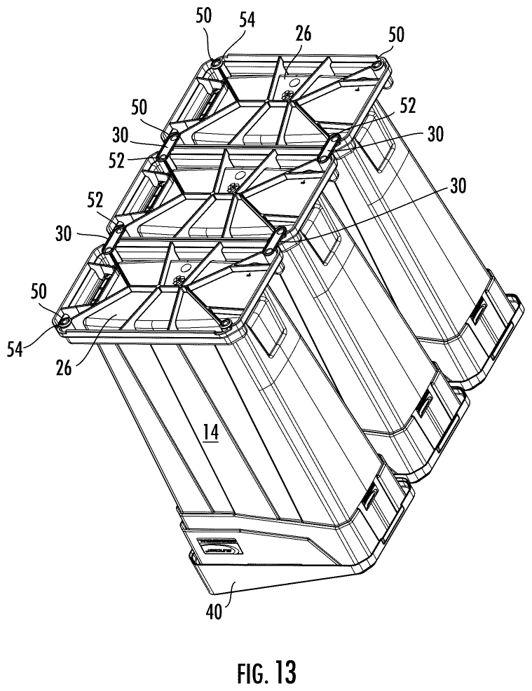

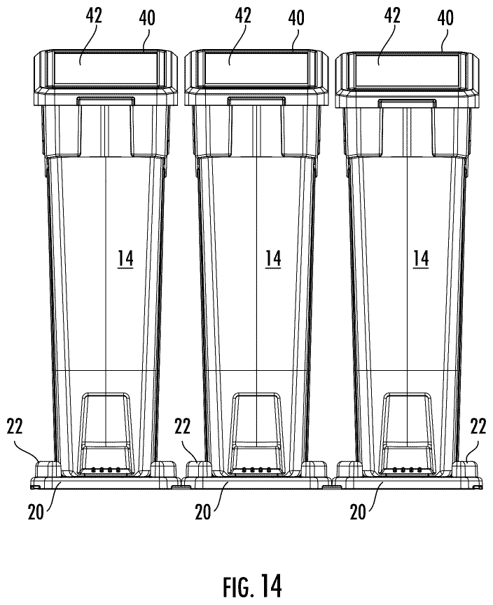

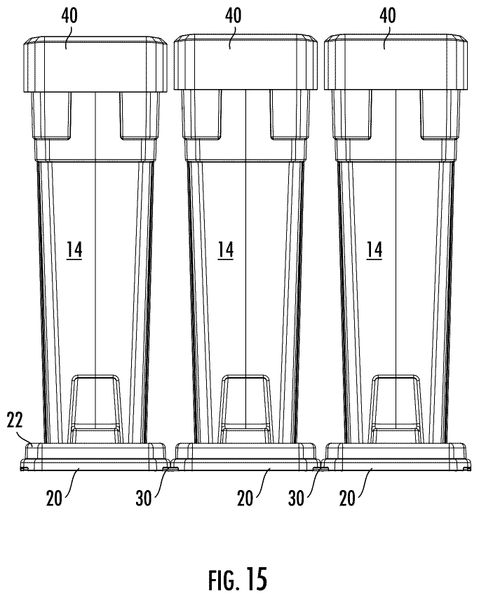

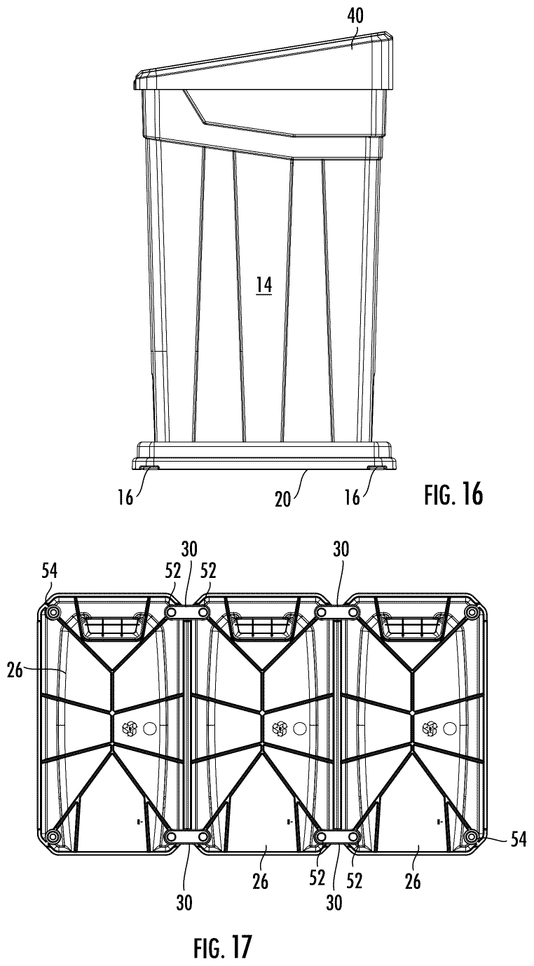

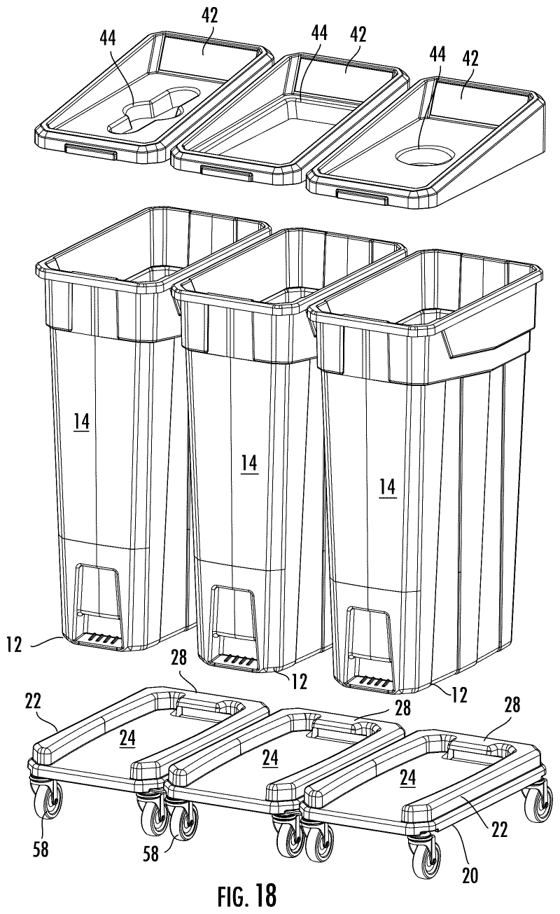

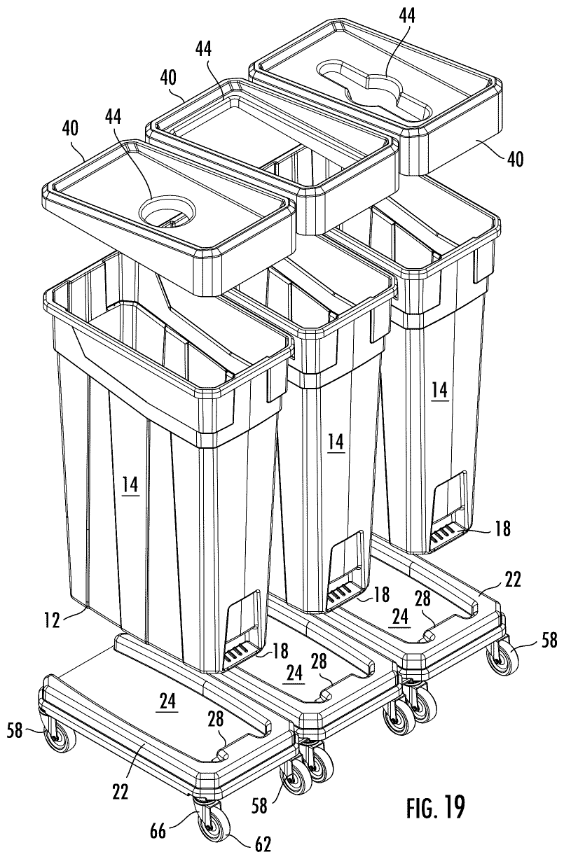

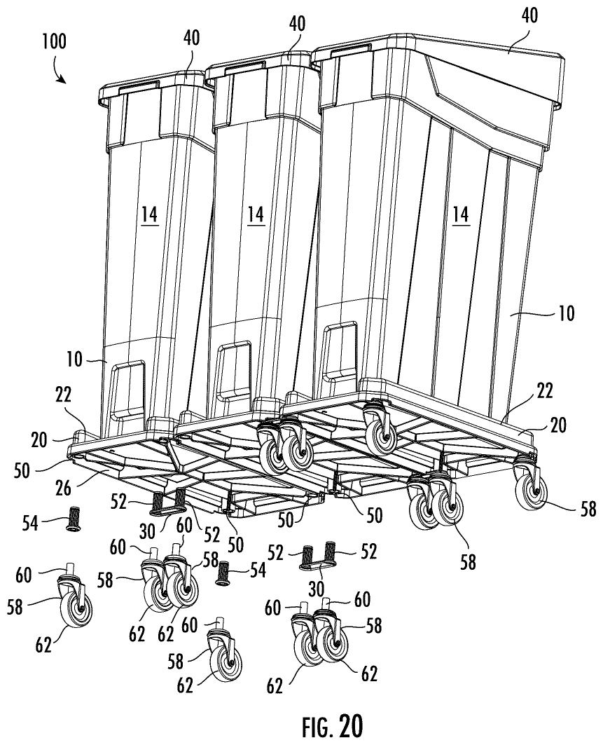

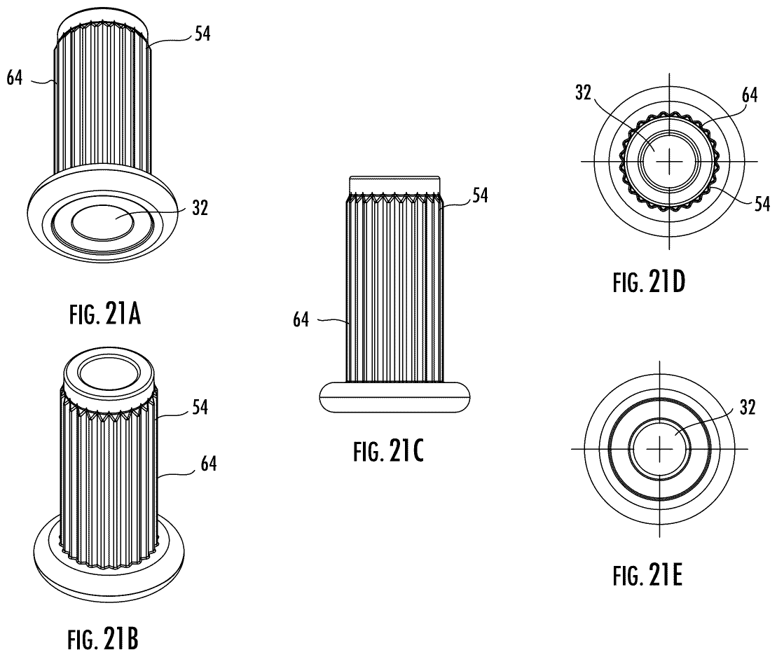

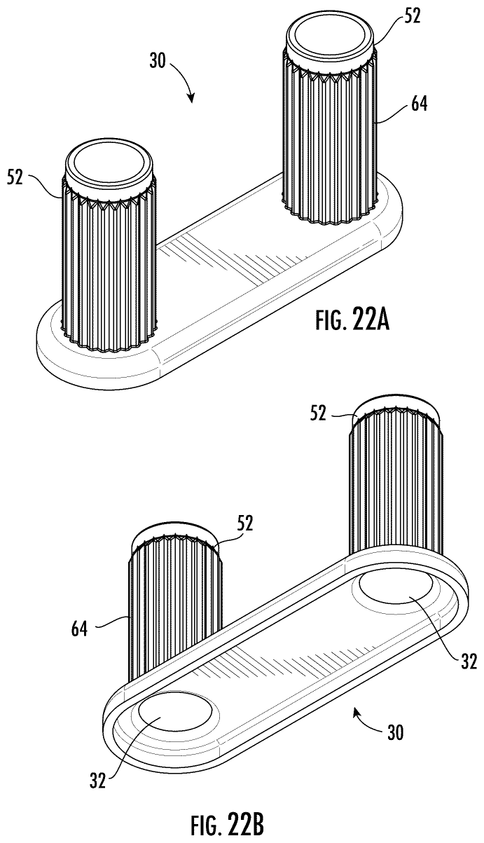

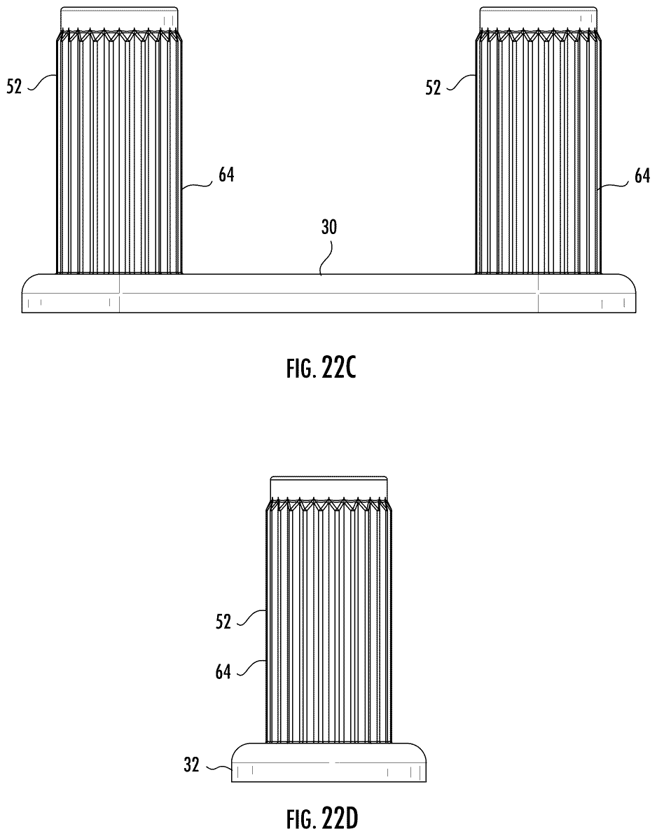

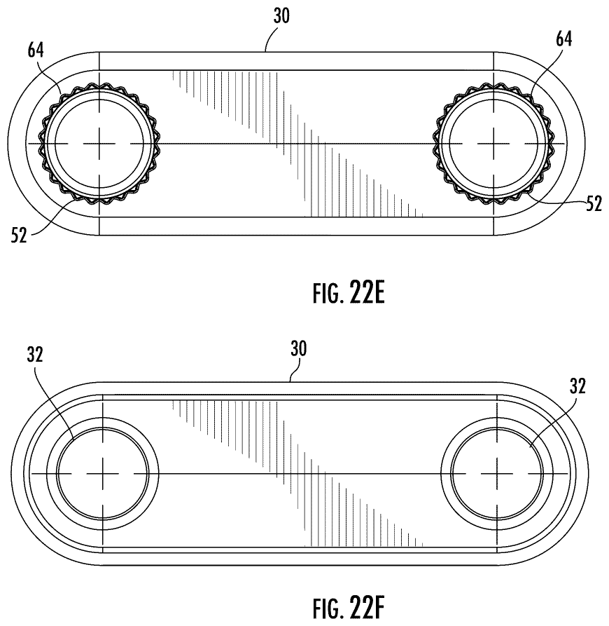

Referring generally to FIGS. 1-22F, a multi-stream trash receptacle assembly 100 is illustrated. The multi-stream trash receptacle assembly includes a receptacle 10 for receiving and holding trash, the receptacle including a bottom wall 12 for supporting the receptacle in an upright position when in contact with a ground surface. A sidewall 14 is integrally formed to and extending completely around a perimeter of the bottom wall 12, the sidewall including a height suitable for receiving and holding trash. While a most-preferred embodiment of the receptacle is constructed to hold about 23 gallons, other sizes of receptacles may be utilized without departing from the scope of the invention. A dolly platform 20 is sized to accept the bottom wall 12 and a portion of the sidewall 14 of the receptacle 10; the dolly platform having a perimeter wall 22 extending around a portion of an upper surface 24 of the dolly platform 20. In a most-preferred embodiment, the perimeter wall extends around at least three sides of the dolly platform. This construction allows the perimeter wall to restrict movement of the receptacle with respect to the dolly to maintain the positioning of the receptacle. The perimeter wall 22 is preferably sized and shaped for cooperating with the sidewall 14 of the receptacle 10 to position the receptacle with respect to the dolly platform 20. In at least one embodiment, the perimeter wall 22 includes an outwardly extending key 28 for engaging a recess 18 positioned in the sidewall 14 of the receptacle 10 to further secure the receptacle to the dolly platform 20. This construction prevents the receptacle from tipping with respect to the dolly and adds considerable stability to the assemblies that include more than one receptacle and dolly.

Still referring generally to the figures, the bottom surface 26 of the dolly platform 20 includes a plurality of blind apertures and, in a most-preferred embodiment, four blind apertures 50 per dolly platform. The blind apertures 50 are sized and shaped to receive either a tie bar post 52 or a caster post 54, and are positioned near the corners of the dolly platform 20 to allow connection to other dolly platforms, either end to end or side by side. The caster post 54 and the tie bar post 52 are preferably like constructed, each having a caster aperture 32 sized and shaped to accept a caster stem 60 in a manner that allows a caster wheel 62 to rotate freely around the caster stem 60. In a most preferred embodiment, an outer surface of the tie bar post 52 and the caster post 54 are constructed to include knurling 64. The knurling 64 provides interference with the sidewalls of the blind apertures to hold the castor post 54 or the tie bar post 52 in position. Tie bars 30 are constructed to reach from the blind aperture 50 of a first dolly platform 20 to the blind aperture 50 of a second dolly platform 20 to connect the dolly platforms together to move and function as a single platform. Thus, even though all of the tie bars 30 include caster apertures 32, the caster assembly 58 need not be used to secure the dolly platforms together. The perimeter wall 22 is provided with a tie bar aperture 16 sized and shaped to allow passage of the tie bar 30 and cooperate with the tie bar 30 sidewalls to locate and prevent rotation of the tie bar, while also allowing a bottom surface 26 of the perimeter wall 22 to sit on a ground surface. Thus, the multi-stream trash can assembly can be utilized with or without casters to retain and position the receptacles. The multi-stream trash receptacle is preferably utilized to separate waste streams for recycling or the like, thus the system is intended to secure two or more dolly platforms and receptacles together into a single assembly. In order to assemble the dolly platforms 20, a first tie bar post 52 is positioned in a blind aperture 50 of a first dolly platform 20 and a second tie bar post 52 from the same tie bar 30 is positioned in a blind aperture 50 of a second dolly platform 20. The two dolly platforms are positioned adjacently with respect to each other and two receptacles 10 are positioned on the two dolly platforms 20. The blind apertures 50 that are not used to connect to an adjacent dolly platform receive a caster post 54. The user can assemble caster assemblies 58 to the caster posts 54 and the tie bar posts 52 to construct a mobile multi-stream trash can, or the assembly can be utilized without casters. In other embodiments, any number of dolly platforms and receptacles can be secured together. For example, including a third dolly platform 20 positioned adjacently to the first or second dolly platform so that at least one tie bar 30 having a pair of tie bar posts 52 can be inserted into a blind aperture 50 of the third platform and a blind aperture 50 of the adjacently positioned dolly platform 20, a third receptacle 10 placed into the third dolly platform, the assembly retaining three receptacles in an adjacent arrangement. This same construction can be utilized to add any number of dolly platforms and receptacles, as desired. Regardless of the number of dolly assemblies, each dolly assembly preferably utilizes four caster assemblies 58 per dolly platform 20. Each caster assembly including a caster stem 60, a caster wheel 62, and a caster swivel 66, a caster stem 60 of each respective caster assembly 58 inserted into a respective caster aperture 32 of a tie bar post 52 or caster post 54 for providing easy movement to the multi-stream trash receptacle. In a most-preferred embodiment, the receptacle 10 and the dolly platform 20 are constructed from polymer; the polymer being a plastic resin suitable for either injection or blow molding, as the receptacle 10 is constructed by blow molding and the dolly platform 20 is constructed by the process of injection molding. In at least some embodiments, the tie bar 30, including the tie bar post 52, and the caster post 54 are also constructed from polymers. However, it should be noted that the caster post, tie bar posts and the tie bar may be constructed from metal without departing from the scope of the invention.

Still referring generally to the figures, the receptacle 10 preferably includes a lid member 40, the lid member including a back splash wall 42, which may be sized to display a label suggesting the trash stream that should be inserted in the receptacle 10. The lid member 40 may also include a shaped central opening 44, the opening shape corresponding to the stream of trash the receptacle is intended to receive, the back splash 42 sloping toward the central opening 44 to direct trash to the opening.

1It is to be understood that while a certain form of the invention is illustrated, it is not to be limited to the specific form or arrangement herein described and shown. It will be apparent to those skilled in the art that various changes may be made without departing from the scope of the invention, and the invention is not to be considered limited to what is shown and described in the specification and any drawings/figures included herein.

1One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A multi-stream trash receptacle (100) comprising:
a receptacle (10) for receiving and holding trash, the receptacle including a bottom wall (12) for supporting the receptacle in an upright position when in contact with a ground surface, a sidewall (14) integrally formed to and extending completely around a perimeter of the bottom wall (12), the sidewall (14) including a height suitable for receiving and holding trash,
a dolly platform (20) sized to accept the bottom wall (12) and a portion of the sidewall (14) of the receptacle (10), the dolly platform (20) having a perimeter wall (22) extending around a portion of an upper surface (24) of the dolly platform (20), the perimeter wall (22) cooperating with the sidewall (14) to position the receptacle (10) with respect to the dolly platform (20), and
at least one tie bar (30) constructed and arranged to engage a portion of the dolly platform (20) and a portion of a second dolly platform (20) to position the dolly platform with respect to the second dolly platform, the perimeter wall (22) including a tie bar aperture (16) sized and shaped to cooperate with the tie bar (30) to locate and prevent rotation of the tie bar (30) with respect to the dolly platform (20), while also allowing a bottom surface (26) of the dolly platform (20) to sit on a ground surface.

2. The multi-stream trash receptacle (100) of claim 1 wherein the receptacle (10) includes a lid member (40), the lid member (40) including a back splash wall (42) and a shaped central opening (44), the opening shape corresponding to the stream of trash the receptacle is intended to receive, the back splash (42) sloping toward the central opening (44) to direct trash to the opening.

3. The multi-stream trash receptacle (100) of claim 1 wherein the perimeter wall (22) includes an outwardly extending key (28) for engaging a recess (18) positioned in the sidewall (14) of the receptacle (10) to further secure the receptacle (10) to the dolly platform (20).

4. The multi-stream trash receptacle (100) of claim 1 wherein the bottom surface (26) of the dolly platform (20) includes four blind apertures (50), the blind apertures (50) sized and shaped to receive either a tie bar post (52) or a caster post (54), the caster post (54) and the tie bar post (52) each having a caster aperture (32) sized and shaped to accept a caster stem (60) in a manner that allows a caster wheel (62) to rotate freely around the caster stem (60).

5. The multi-stream trash receptacle (100) of claim 4 wherein an outer surface of the tie bar post (52) and the caster post (54) include knurling (64).

6. The multi-stream trash receptacle (100) of claim 4 wherein a first tie bar post (52) is positioned in a blind aperture (50) of a first dolly platform (20) and a second tie bar post (52) from the same tie bar (30) is positioned in a blind aperture (50) of a second dolly platform (20), wherein the two dolly platforms are positioned adjacently with respect to each other and two receptacles (10) are positioned on the two dolly platforms (20).

7. The multi-stream trash receptacle (100) of claim 6 wherein a second tie bar (30) having a pair of tie bar posts (52) is inserted into a blind aperture (50) of the first dolly platform (20) and a blind aperture (50) of the second dolly platform (20).

8. The multi-stream trash receptacle (100) of claim 7 including a third dolly platform (20) positioned adjacently to the first or second dolly platform so that at least one tie bar (30) having a pair of tie bar posts (52) can be inserted into a blind aperture (50) of the third platform (20) and a blind aperture (50) of the adjacently positioned dolly platform (20), a third receptacle (10) placed into the third dolly platform (20), the assembly retaining three receptacles (10) in an adjacent arrangement.

9. The multi-stream trash receptacle (100) of claim 4 including four caster assemblies (58), each caster assembly including a caster stem (60), a caster wheel (62) and a caster swivel (66), a caster stem (60) of each respective caster assembly (58) inserted into a respective caster aperture (32) of a tie bar post (52) or caster post (54) for providing easy movement to the multi-stream trash receptacle.

10. The multi-stream trash receptacle (100) of claim 8 including four caster assemblies (58) in each dolly platform (20), each caster assembly including a caster stem (60), a caster wheel (62) and a caster swivel (66), a caster stem (60) of each respective caster assembly (58) inserted into a respective caster aperture (32) of a tie bar post (52) or caster post (54) for providing easy movement to the multi-stream trash receptacle.

11. The multi-stream trash receptacle (100) of claim 2 wherein the back splash wall (42) of each lid member (40) is sized to include a label regarding the waste stream of trash the receptacle is intended to receive.

12. The multi-stream trash receptacle of claim 1 wherein the receptacle (10) and the dolly platform (20) are constructed from polymer.

13. The multi-stream trash receptacle of claim 12 wherein the polymer is plastic resin.
